(19) United States
(12) Patent Application Publication
(10) Pub. No.: US 2007/0023262 A1
(43) Pub. Date: Feb. 1, 2007

(54) KEYPAD AND MANUFACTURING METHOD THEREOF

(76) Inventors: Dean-Kuo Liu, Taoyuan County (TW); Lu-Chin Wu, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/164,140

(22) Filed: Nov. 11, 2005

(30) Foreign Application Priority Data
Jul. 27, 2005 (TW) 94125381

(51) Int. Cl. H01H 13/70

(52) U.S. Cl. 200/5 R

(57) ABSTRACT

A method for manufacturing a keypad is provided. First, a patterned metallic sheet is provided. This patterned metallic sheet has a front surface and a rear surface and includes a plurality of key units that can be operated independently. These key units have a plurality of hollow structures thereon. Then, an adhesion-enhancing layer is formed on the rear surface of the patterned metallic sheet. Next, a color layer is formed on the adhesion-enhancing layer. A protruding point layer is formed on the adhesion-enhancing layer to cover the color layer. The protruding point layer has a plurality of protruding points that correspond to the positions of the key units. Finally, a light emitting device layer is disposed on the protruding point layer. The keypad manufactured according the disclosed method has a better light transmitting uniformity.

### CROSS-REFERENCE TO RELATED APPLICATION

This application claims the priority benefit of Taiwan application serial no. 94125381, filed on Jul. 27, 2005. All disclosure of the Taiwan application is incorporated herein by reference.

### BACKGROUND OF THE INVENTION

1. Field of the Invention

The present invention relates to a keypad and manufacturing method thereof. More particularly, the present invention relates to a keypad with a better light transmitting uniformity and the manufacturing method thereof.

2. Description of the Related Art

In this information explosion era, electronic devices have become an indispensable part of our life. In particular, various portable electronic devices including the mobile phones and the personal digital assistants (PDA) are used almost every day. To attract more consumers, the outward appearance and design of portable electronic devices are constantly changing. Although most consumers will definitely consider the price and function when selecting a portable electronic product, more and more consumers also require a product with a more beautiful design. Hence, the conventionally and dully rectangular portable electronic products are gradually replaced by those with curved or other novel shapes. To fit into various types of new portable electronic devices, many different kinds of keypad designs are introduced. Despite the variety, a major consideration regarding the design of the keypad is still the sense of touch felt by the user. In general, although a plastic keypad can still be decorated after performing treatments such as color spraying and laser etching, a metallic luster on the surface is difficult to achieve. Furthermore, in order to let the user see the keys clearly in the dark, light-emitting diodes are disposed under the keys to serve as light source for illuminating the portable electronic device.

FIG. 1A is a top view of a conventional mobile phone and FIG. 1B is a cross-sectional view along line A-A′ of the mobile phone shown in FIG. 1A. As shown in FIGS. 1A and 1B, the mobile phone 100 comprises a keypad 110, a keypad circuit board 120, a display screen 130, an outer casing 140 and an antenna 150. The keypad 110, the display screen 130 are disposed on top of the outer casing 140 and the keypad circuit board 120 is disposed under the keypad 110 and enclosed by the outer casing 140. The antenna 150 is connected to the outer casing 140.

The keypad 110 has a plastic sheet 112, a plurality of keys 116 and a protruding point layer 118. The keys 116 have a plurality of transparent patterns 116a and the protruding point layer 118 is disposed on the rear surface 114b of the plastic sheet 112. Furthermore, the protruding point layer 118 has a plurality of protruding points 118a thereon. The keypad 110 is disposed on the keypad circuit board 120. Furthermore, the keypad circuit board 120 comprises a circuit board 122, a plurality of light-emitting diodes 124, a plurality of metallic elastic plates 126 and a plurality of fixed contact points 128. The light-emitting diodes 124 are disposed on the circuit board 122 for providing the light sources needed for illuminating the transparent patterns 116a of the keys 116. The light emitted by the light-emitting diode 124 preferably has a preferred illuminating range 124a. Within the preferred illuminating range 124a of the light-emitting diode 124, the light intensity is stronger and more uniform. On the other hand, beyond the preferred illuminating range 124a, the light intensity is weaker and diffused. Using the light-emitting diode 124 on the left side of FIG. 1B as an example, two of the transparent patterns 116a are located within the preferred illuminating range 124a of the light-emitting diode 124 while one of the transparent patterns 116a is located outside of the range. The light emitting from the two transparent patterns 116a within the preferred illuminating range 124a is stronger and more uniform, whereas the light emitting from the single transparent pattern 116a outside of the preferred illuminating range 124a is weaker and non-uniform. Because some of the transparent patterns 116a are located outside of the preferred illuminating range 124a, a few of the transparent patterns 116a appear to have rather weak and non-uniform illumination. Furthermore, their clarity becomes poor. When the effects of all the preferred illuminating range 124a of the light-emitting diode 124 are taken into consideration, the clarity of many transparent patterns 116a on the keypad 110 is unacceptable.

In addition, the thinner and lighter the mobile phone 100 is, the narrower and smaller the interior space of the mobile phone 100 is. Consequently, the preferred illuminating range 124a of the light-emitting diode 124 will be affected, which causes more transparent patterns 116a fallen outside of the preferred illuminating range 124a of the light-emitting diodes 124. As a result, the clarity of the imprinted words or patterns will be deteriorated.

### SUMMARY OF THE INVENTION

Accordingly, at least one objective of the present invention is to provide a method of fabricating a keypad having a better light transmitting uniformity.

At least another objective of the present invention is to provide a keypad with a better light transmitting uniformity.

To achieve these and other advantages and in accordance with the purpose of the invention, as embodied and broadly described herein, the invention provides a method of fabricating a keypad comprising the following steps. First, a patterned metallic sheet is provided. This patterned metallic sheet has a front surface and a rear surface and includes a plurality of key units that can be operated independently. These key units have a plurality of hollow pattern structures thereon. Then, an adhesion-enhancing layer is formed on the rear surface of the patterned metallic sheet. A color layer is formed on the adhesion-enhancing layer. A protruding point layer is formed on the adhesion-enhancing layer to cover the color layer. The protruding point layer has a plurality of protruding points that corresponds to the positions of the key units respectively. Finally, a light emitting device layer is disposed on the protruding point layer as a uniform planar light source.

According to the method of fabricating the keypad in the embodiment of the present invention, the steps for forming the patterned metallic sheet includes providing a thin metallic sheet and etching or cutting the thin metallic sheet to form the patterned metallic sheet.

According to the method of fabricating the keypad in the embodiment of the present invention, the step of forming the color layer includes performing a printing, a transfer printing or a spray coating process, for example.

According to the method of fabricating the keypad in the embodiment of the present invention, the step of forming the protruding point layer includes performing an injection molding or a hot-press molding process, for example.

According to the method of fabricating the keypad in the embodiment of the present invention, the step of forming the protruding point layer further includes pressing part of the adhesion-enhancing layer into the hollow pattern structures.

According to the method of fabricating the keypad in the embodiment of the present invention, further includes trimming off any redundant material at the periphery of the patterned metallic sheet after forming the protruding point layer.

The present invention also provides a keypad comprising a patterned metallic sheet, an adhesion-enhancing layer, a color layer, a protruding point layer and a light-emitting device layer. The patterned metallic sheet has a front surface and a rear surface and includes a plurality of key units that can be operated independently. These key units have a plurality of hollow structures thereon. The adhesion-enhancing layer is disposed on the rear surface of the patterned metallic sheet. The color layer is disposed on the adhesion-enhancing layer. The protruding point layer is disposed on the adhesion-enhancing layer to cover the color layer. The protruding point layer has a plurality of protruding points that correspond to the positions of the key units respectively. Finally, the light emitting device layer is disposed on the protruding point layer as a uniform planar light source.

According to the keypad in the embodiment of the present invention, the light-emitting layer includes an inorganic light-emitting layer or an organic light-emitting layer, for example.

According to the keypad in the embodiment of the present invention, part of the adhesion-enhancing layer also fills the hollow pattern structures, for example.

According to the keypad in the embodiment of the present invention, the material constituting the adhesion-enhancing layer includes thermoplastic polyurethane (TPU), thermal plastic rubber (TPR) or thermoplastic resin, for example.

According to the keypad in the embodiment of the present invention, the material constituting the protruding point layer includes thermoplastic elastomer, for example.

According to the keypad in the embodiment of the present invention, the material constituting the protruding point layer includes silicone rubber, thermoplastic polyurethane (TPU), thermal plastic rubber (TPR) or thermoplastic resin, for example.

In brief, the keypad of the present invention is fabricated using a metallic sheet. Therefore, it has a metallic luster and a solid three-dimensional metallic feeling. Furthermore, the method of fabricating the keypad includes disposing a light-emitting device layer on the protruding point layer to serve as a planar light source for illuminating the keypad uniformly. Hence, any non-uniformity in the light leaking from the hollow pattern structures is avoided and a better illuminating range is provided. Ultimately, the keypad of the present invention has a better light transmitting uniformity.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a top view of a conventional mobile phone.

FIG. 1B is a cross-sectional view along line A-A′ of the mobile phone shown in FIG. 1A.

FIG. 2 is a perspective view of a patterned metallic sheet.

FIGS. 3A through 3E are schematic cross-sectional views showing the steps for forming a keypad according to one preferred embodiment of the present invention.

FIG. 4 is a schematic cross-sectional view showing an assembled keypad and keypad circuit board according to one preferred embodiment of the present invention.

FIG. 5 is a perspective view of a mobile phone having the keypad according to the preferred embodiment of the present invention.

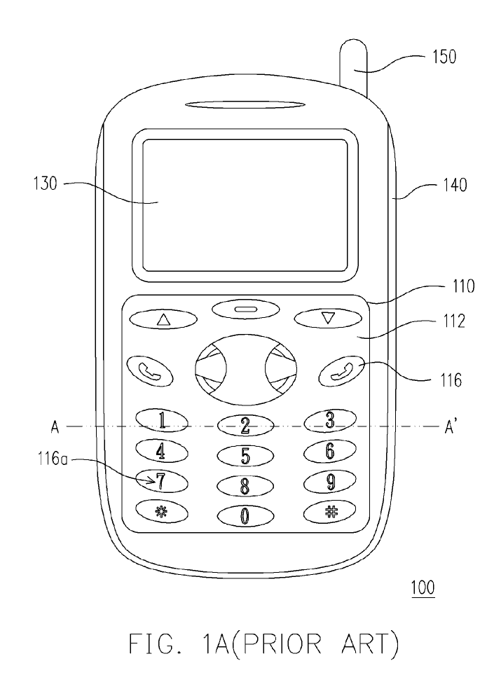

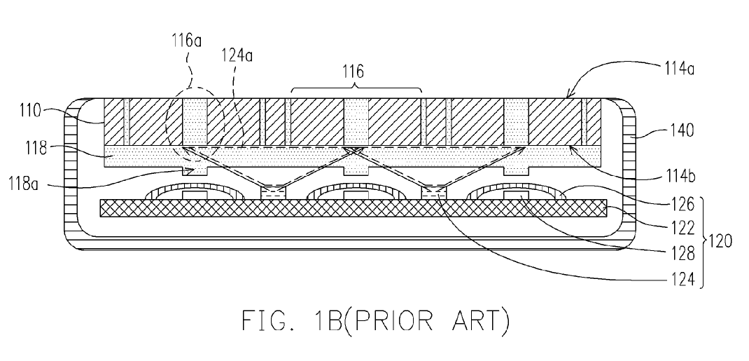

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

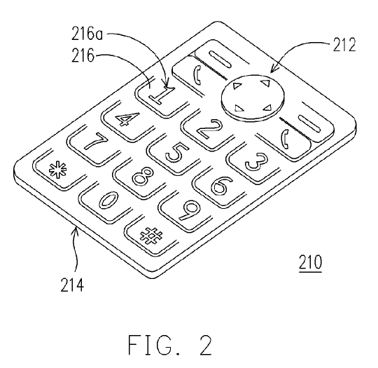

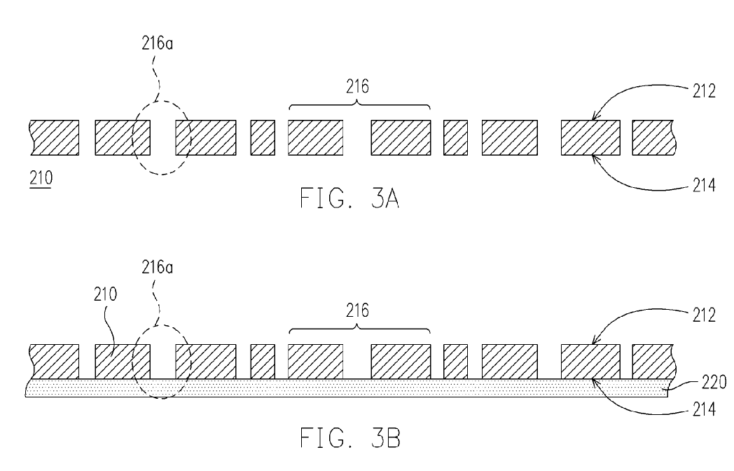

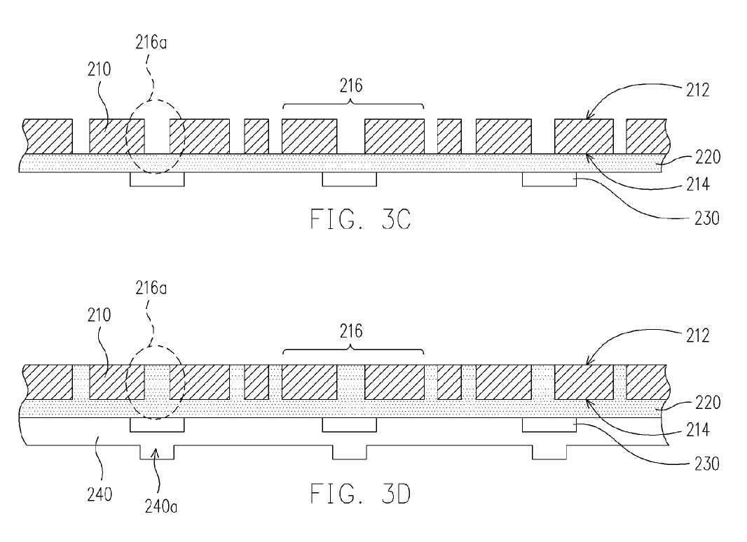

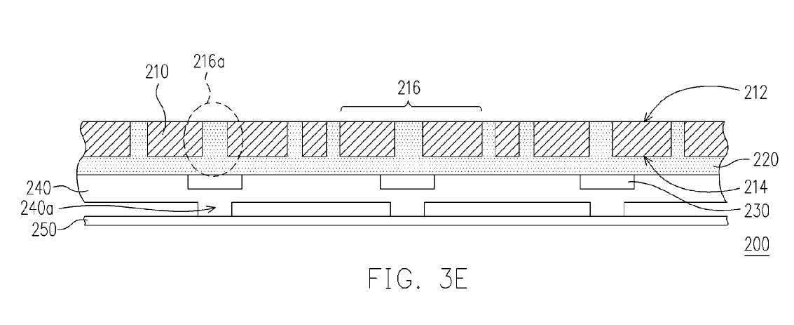

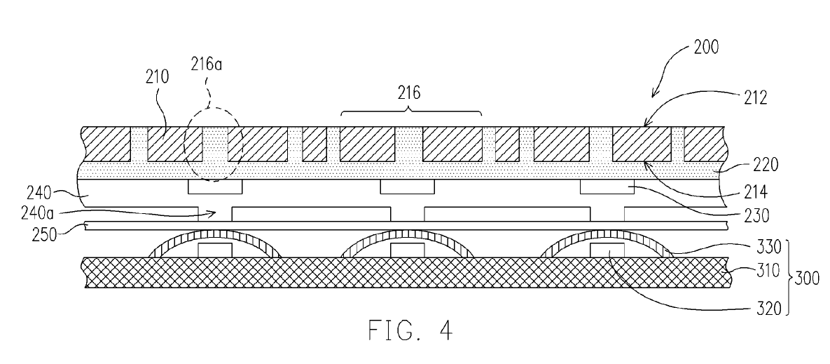

FIG. 2 is a perspective view of a patterned metallic sheet. FIGS. 3A through 3E are schematic cross-sectional views showing the steps for forming a keypad according to one preferred embodiment of the present invention. As shown in FIGS. 2 and 3A, the method of fabricating a keypad according to the present embodiment includes providing a patterned metallic sheet 210. The method of fabricating the patterned metallic sheet 210 includes providing a standard uncut metallic sheet (not shown) and performing an etching or cutting operation to pattern the metallic sheet. The patterned metallic sheet 210 has a front surface 212 and a rear surface 214 and includes a plurality of independently operated key units 216. The key units 216 have a plurality of hollow pattern structures 216a thereon. More specifically, each key unit 216 has at least one hollow pattern structure 216a.

As shown in FIG. 3B, an adhesion-enhancing layer 220 is disposed on the rear surface 214 of the patterned metallic sheet 210. The adhesion-enhancing layer 220 is fabricated using thermoplastic polyurethane (TPU), thermal plastic rubber (TPR), thermoplastic resin or other suitable material, for example.

As shown in FIG. 3C, a color layer 230 is formed over the adhesion-enhancing layer 220. The method of forming the color layer 230 includes, for example, performing a printing, a transfer printing, a spray coating process or other suitable process. In addition, the color layer 230 is not limited to a single color or a single layer. According to the actual specifications, the color layer 230 may include a plurality of colors or a plurality of layers (not shown). Furthermore, there is no particular restriction on the distribution of the various colors.

As shown in FIG. 3D, a protruding point layer 240 is formed on the adhesion-enhancing layer 220 to cover the color layer 230. The protruding point layer 240 has a plurality of protruding points 240a located in various positions that correspond to the respective key units 216 respectively. The method of forming the protruding point layer 240 includes performing an injection molding, hot press molding or other suitable process. The protruding point layer 240 is fabricated using thermal plastic elastomer, silicone rubber, thermoplastic polyurethane, thermal plastic rubber, thermoplastic resin or other suitable material, for example.

Furthermore, part of the adhesion-enhancing layer 220 may be pressed into the interior of the hollow pattern structures 216a. The adhesion-enhancing layer 220 may even protrude slightly from the hollow pattern structures 216a to prevent any dust from accumulating within the hollow pattern structures 216a and provide the blind with means of identifying the relative position of variouskey units 216. In addition, the peripheral portion of the patterned metallic sheet 210 may be trimmed to produce a more aesthetically appealing shape after forming the protruding point layer 240.

As shown in FIG. 3E, a light-emitting device layer 250 is formed on the protruding point layer 240, as a uniform planar light source, to provide illumination. The method of disposing the light-emitting device layer 250 includes coating a layer of adhesive plastic over the protruding points 240a and attaching the light-emitting layer 250 to the protruding point layer 240. The light-emitting device layer 250 is, for example, an inorganic light-emitting layer, an organic light-emitting layer or other suitable light-emitting material layer. As an example, the light-emitting device layer 250 comprises a top electrode, a bottom electrode layer (both not shown) and an inorganic light-emitting material layer or an organic light-emitting material layer (not shown) sandwiched between them. Moreover, the light-emitting device layer 250 can be designed with the needed shape, thickness and color to produce the required illuminating effects according to the pattern or number on the hollow pattern structures 216a. Up to this point, the fabrication of the keypad 200 is mostly complete.

In the following, the structure and the function of various parts of the keypad 200 are described. As shown in FIG. 3E, the keypad 200 in the present embodiment comprises a patterned metallic sheet 210, an adhesion-enhancing layer 220, a color layer 230, a protruding point layer 240 and a light-emitting device layer 250. The patterned metallic sheet 210 has a front surface 212 and a rear surface 214 and includes a plurality of independently operated key units 216. The key units 216 have a plurality of hollow pattern structures 216a thereon.

Since the patterned metallic sheet 210 is a metallic plate, the front surface 212 of the patterned metallic sheet 210 and the surface, the side and gaps of the hollow pattern structures 216a can reflect light. Therefore, the keypad 200 has a metallic luster and a three-dimensional solid feeling.

The adhesion-enhancing layer 220 is disposed on the rear surface 214 of the patterned metallic sheet 210. The color layer 230 is disposed on the adhesion-enhancing layer 220. The protruding point layer 240 is further disposed on the adhesion-enhancing layer 220 to cover the color layer 230. The protruding point layer 240 has a plurality of protruding points 240a disposed in positions that correspond to the respective key units 216 respectively.

It should be noted that the adhesion between the protruding point layer 240 and the patterned metallic sheet 210 would be worse if the protruding point layer 240 is directly disposed on the rear surface 214 of the patterned metallic sheet 210. Therefore, in the present embodiment, an adhesion-enhancing layer 220 is attached to the rear surface 214 of the patterned metallic sheet 210 first. Because the adhesion between the patterned metallic sheet 210 and the adhesion-enhancing layer 220 and the adhesion between the protruding point layer 240 and the adhesion-enhancing layer 220 are strong, the problem of having poor adhesion between the protruding point layer 240 and the patterned metallic sheet 210 is resolved. In addition, the adhesion-enhancing layer 220 also serves as a basis for attaching the color layer 230 because it is difficult to directly adhere the color layer 230 to the patterned metallic sheet 210.

The light-emitting device layer 250 is disposed on the protruding point layer 240. The purpose of the light-emitting device layer 250 is to provide a uniform planar light source for illuminating the hollow pattern structures 216a on the key units 216. Because the light-emitting device layer 250 completely covers the protruding point layer 240 and the layered structure generates a planar light source, the key units 216 and the hollow pattern structures 216a are provided with a better illuminating range, and thus the illuminating effect is enhanced. Furthermore, the intensity of the light emitted from the light-emitting device layer 250 is uniform. Hence, the hollow pattern structures 216a can pour out uniform streams of light so that the letters or graphics on the key units 216 observed by the user are clear and distinct.

FIG. 4 is a schematic cross-sectional view showing an assembled keypad and keypad circuit board according to one preferred embodiment of the present invention. As shown in FIG. 4, the keypad 200 is disposed on a keypad circuit board 300. The keypad circuit board 300 comprises a circuit board 310, a plurality of fixed contacts 320 and a plurality of dome-shaped metallic springs 330. The fixed contacts 320 and the dome-shaped metallic springs 330 are disposed on the circuit board 310. Furthermore, each dome-shaped metallic spring 330 is disposed in a position to correspond with a fixed contact 320 without actually in contact with the fixed contact 320. Each protruding point 240a in the protruding point layer 240 is suitable to be in contact with the dome-shaped metallic spring 330 via the light-emitting device layer 250. When a user presses down a key unit 216, the corresponding protruding point 240a of the key unit 216 will compress the dome-shaped metallic spring 330 so that the dome-shaped metallic spring 330 and the corresponding fixed contact 320 are in contact with each other. Through the contact between the dome-shaped metallic spring 330 and the fixed contact 320, the user is able to feed data into a portable electronic device such as a mobile phone or a personal digital assistant. Furthermore, since the light-emitting device layer 250 has a relatively small thickness, the light-emitting device layer 250 has little effect in the process of pressing the protruding point 240a against the dome-shaped metallic spring 330.

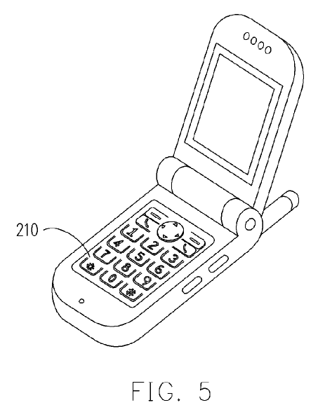

FIG. 5 is a perspective view of a mobile phone having the keypad according to the preferred embodiment of the present invention. With the metallic luster and three-dimensional metallic solid feeling, the aesthetic appeal of the mobile phone with the keypad manufactured according to the preferred embodiment of the present invention is increased significantly. Moreover, with a stream of uniform light beam emitting from the hollow pattern structures 216a ofkey units 216, letters or pattern on the keys can be clearly seen.

In practice, the keypad of the present embodiment is not limited to the manufacture of mobile phones. According to various requirements, the present embodiment can be applied to other portable electronic devices for enhancing their aesthetic appeal as well.

In summary, the keypad and manufacturing method thereof in the present invention has at least the following advantages:

1. The keypad is fabricated using a metallic sheet and hence has metallic luster and solid three-dimensional feeling.

2. The thickness of a portable electronic device can be significantly reduced when the metallic sheet is used to fabricate the keypad.

3. Since the keypad is fabricated using a metallic material, it has the function of shielding off electromagnetic interference. In other words, there is no need to provide additional shielding against electromagnetic radiation.

4. The fabrication of the keypad includes disposing a surface type light-emitting device layer on the protruding point layer to provide a planar light source for illuminating the keypad so that uniform beams of light can be emitted from the hollow pattern structures. Thus, the keypad provided by the present invention has better transmission uniformity.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of manufacturing a keypad, comprising:
providing a patterned metallic sheet, wherein the patterned metallic sheet has a front surface and a rear surface and includes a plurality of independently operated key units, and the key units have a plurality of hollow pattern structures thereon;
disposing an adhesion-enhancing layer on the rear surface of the patterned metallic sheet;
forming a color layer on the adhesion-enhancing layer;
forming a protruding point layer on the adhesion-enhancing layer to cover the color layer, the protruding point layer has a plurality of protruding points, wherein the protruding points are disposed in locations that correspond to the respective key units; and
disposing a light-emitting device layer on the protruding point layer as a uniform planar light source.

2. The method of claim 1, wherein the steps for forming the patterned metallic sheet include:
providing a thin metallic sheet; and
etching or cutting the thin metallic sheet into the patterned metallic sheet.

3. The method of claim 1, wherein the step of forming the color layer includes performing a printing, a transfer printing or a spray coating process.

4. The method of claim 1, wherein the step of forming the protruding point layer includes performing an injection molding or hot press molding process.

5. The method of claim 1, wherein the step of forming the protruding point layer further includes pressing part of the adhesion-enhancing layer into the hollow pattern structures.

6. The method of claim 1, further includes trimming away some redundant material at the peripheral portion of the patterned metallic sheet after forming the protruding point layer.

7. A keypad, comprising:
a patterned metallic sheet having a front surface and a rear surface, wherein the patterned metallic sheet includes a plurality of independently operated key units, and the key units have a plurality of hollow pattern structures thereon;
an adhesion-enhancing layer disposed on the rear surface of the patterned metallic sheet;
a color layer disposed on the adhesion-enhancing layer;
a protruding point layer disposed on the adhesion-enhancing layer to cover the color layer, wherein the protruding point layer has a plurality of protruding points, and the protruding points are disposed in locations that correspond to the respective key units; and
a light-emitting device layer disposed on the protruding point layer as a uniform surface light source.

8. The keypad of claim 7, wherein the light-emitting device layer further includes an inorganic light-emitting device layer or an organic light-emitting device layer.

9. The keypad of claim 7, wherein part of the adhesion-enhancing layer fills the interior of the hollow pattern structures.

10. The keypad of claim 7, wherein the material constituting the adhesion-enhancing layer includes thermoplastic polyurethane (TPU), thermal plastic rubber (TPR) or thermoplastic resin.

11. The keypad of claim 7, wherein the material constituting the protruding point layer includes thermoplastic elastomer.

12. The keypad of claim 7, wherein the material constituting the protruding point layer includes silicone rubber, thermoplastic polyurethane (TPU), thermal plastic rubber (TPR) or thermal plastic resin.
